(19) United States
(12) Patent Application Publication
(10) Pub. No.: US 2026/0312396 A1
(43) Pub. Date: Oct. 8, 2026

(54) OVER-VOLTAGE TRANSIENT PROTECTION IN ELECTRICAL CIRCUIT

(71) Applicant: Cisco Technology, Inc., San Jose, CA (US)

(72) Inventors: Xiqun Zhu, Cupertino, CA (US); Alpesh U Bhobe, Sunnyvale, CA (US); Paolo Sironi, Gallarate (IT); Joel Richard Goergen, Soulsbyville, CA (US)

(21) Appl. No.: 19/098,881

(22) Filed: Apr. 2, 2025

(51) Int. Cl. H02H 3/20; G01R 19/165; H02H 1/00

(52) U.S. Cl. CPC H02H 3/202; G01R 19/16538; H02H 1/0007

(57) ABSTRACT

An over-voltage transient protection circuit dynamically protects electrical circuits from voltage spikes by monitoring a voltage level of an input voltage and activating a clamping element when the voltage level exceeds a voltage threshold. The over-voltage transient protection circuit includes a clamping element that has a maximum continuous operating voltage lower than a continuous voltage associated with an electrical circuit. The over-voltage transient protection circuit further includes a switching element coupled in series with the clamping element, operable in a conducting state or a non-conducting state. The over-voltage transient protection circuit further includes a switch controller coupled to the switching element. The switch controller is configured to transition the switching element from the non-conducting state to the conducting state in response to a voltage spike. In the conducting state, the switching element establishes a connection between the clamping element and one or more circuit elements of the electrical circuit.

### BACKGROUND

The present disclosure relates to electrical circuits. More particularly, the present disclosure relates to protection of the electrical circuits from over-voltage transients using dynamically controlled clamping mechanisms.

Electrical circuits, for example, used in industrial, automotive, power supply environments, or the like, are vulnerable to damage from over-voltage transients (or voltage spikes) caused by lightning strikes, power line disturbances, or switching events. To mitigate risks associated with the over-voltage transients, protection devices, for example, Metal Oxide Varistors (MOVs), Transient Voltage Suppressors (TVS), and Gas Discharge Tubes (GDTs), are utilized. These protection devices clamp excessive voltages and divert transient energy away from sensitive electrical circuit components.

Existing protection devices are configured to activate when the voltage exceeds a clamping threshold. However, the clamping threshold of these devices is set much higher than normal operating voltage of electrical circuits. In addition, these protection devices operate with fixed clamping thresholds, which may not be adaptable to changing input voltage conditions. As a result, these protection devices may provide insufficient protection during voltage surges or during transient voltage fluctuations. Consequently, electrical circuits that operate at low voltages may experience over-voltage events, where these protection devices may either get activated too late or fail to activate entirely due to the wide tolerance in clamping thresholds.

### SUMMARY OF THE DISCLOSURE

Systems and methods for over-voltage transient protection in electrical circuits using dynamically controlled clamping mechanisms in accordance with embodiments of the disclosure are described herein.

In a variety of embodiments, an electrical circuit including a pair of terminals may be configured to receive an input voltage, one or more circuit elements coupled between the pair of terminals, and an over-voltage transient protection circuit coupled between the pair of terminals and to the one or more circuit elements. The over-voltage transient protection circuit may further include a clamping element, and a switching element coupled in series with the clamping element between the pair of terminals and operable in a conducting state or a non-conducting state based on a voltage spike being present or absent in the input voltage, respectively. In the over-voltage transient protection circuit during the non-conducting state, the switching element may isolate the clamping element from the one or more circuit elements, and in the conducting state, the switching element may establish a connection between the clamping element and the one or more circuit elements.

In further embodiments, a maximum continuous operating voltage associated with the clamping element may be less than a continuous voltage associated with the electrical circuit.

In further more embodiments, the over-voltage transient protection circuit may include a switch controller configured to detect whether the voltage spike is present in the input voltage based on a voltage level of the input voltage and a voltage threshold.

In a number of embodiments, the voltage spike may be detected as absent in the input voltage based on the voltage level of the input voltage being less than the voltage threshold.

In many embodiments, the voltage spike may be detected as present in the input voltage based on the voltage level of the input voltage exceeding the voltage threshold.

In a number of embodiments, the switch controller may be coupled to the switching element and be configured to control a switching operation of the switching element based on the detection of whether the voltage spike is present in the input voltage.

In various embodiments, controlling the switching operation of the switching element may include operating the switching element in the non-conducting state based on the detection that the voltage spike is absent in the input voltage.

In further embodiments, controlling the switching operation of the switching element may include causing the switching element to transition from the non-conducting state to the conducting state in response to the detection that the voltage spike is present in the input voltage.

In a variety of embodiments, controlling the switching operation of the switching element may include operating the switching element in the conducting state at least until the voltage spike in the input voltage persists.

In many embodiments, controlling the switching operation of the switching element may include causing the switching element to transition from the conducting state to the non-conducting state in response to cessation of the voltage spike in the input voltage.

In a variety of embodiments, the switch controller may further be configured to receive a setting input for the voltage threshold.

In numerous embodiments, the voltage threshold may be configurable based on the setting input.

In still more embodiments, the over-voltage transient protection circuit may further include an input voltage monitoring circuit coupled to the switch controller and configured to monitor the voltage level of the input voltage, and transmit the monitored voltage level.

In a number of embodiments, to detect whether the voltage spike is present in the input voltage, the switch controller may further be configured to receive the voltage level from the input voltage monitoring circuit.

In more embodiments, the electrical circuit may include a control logic configured to receive the monitored voltage level, determine the voltage threshold based on the monitored voltage level received over a time period, and provide a setting input that configures the switch controller with the voltage threshold.

In a number of embodiments, the over-voltage transient protection circuit may further be configured to generate an indication based on the voltage spike being present in the input voltage.

In several more embodiments, a control logic may be configured to track one or more instances of voltage spikes in the input voltage based on the generated indication.

In several embodiments, an over-voltage transient protection circuit to protect an electrical circuit from voltage spikes may include a clamping element that has a maximum continuous operating voltage lower than a continuous voltage associated with the electrical circuit, a switching element coupled in series with the clamping element and operable in a conducting state or a non-conducting state, and a switch controller coupled to the switching element and configured to transition the switching element from the non-conducting state to the conducting state in response to a voltage spike.

In a variety of embodiments, a method to protect an electrical circuit from voltage spikes may include detecting, by an over-voltage transient protection circuit in the electrical circuit, a voltage spike in an input voltage. The over-voltage transient protection circuit may include a clamping element that is normally isolated from one or more circuit elements of the electrical circuit, and has a maximum continuous operating voltage lower than a continuous voltage associated with the electrical circuit. The method may further include establishing a connection between the clamping element and the one or more circuit elements in response to detecting the voltage spike.

In further embodiments, the method may further include detecting a cessation of the voltage spike in the input voltage, and re-isolating the clamping element from one or more circuit elements in response to detecting the cessation of the voltage spike in t1he input voltage.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual block diagram of an electrical circuit including an over-voltage transient protection circuit in accordance with various embodiments of the disclosure;

FIG. 2 is a conceptual block diagram of an over-voltage transient protection circuit that additionally provides voltage spike indication in accordance with various embodiments of the disclosure;

FIG. 3 is a conceptual block diagram of an over-voltage transient protection circuit that operates based on a dynamically configurable voltage threshold in accordance with various embodiments of the disclosure;

FIG. 4 is a flowchart depicting a process for protecting an electrical circuit from a voltage spike in an input voltage in accordance with various embodiments of the disclosure;

FIG. 5 is a flowchart depicting a process for protecting an electrical circuit against voltage spikes in an input voltage in accordance with various embodiments of the disclosure;

FIG. 6 is a flowchart depicting a process for protecting an electrical circuit against voltage spikes in an input voltage using an over-voltage transient protection circuit in accordance with various embodiments of the disclosure;

FIG. 7 is a flowchart depicting a process for generating an indication to indicate an instance of voltage spike in accordance with various embodiments of the disclosure; and

FIG. 8 is a conceptual block diagram of a device capable of executing a control logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for over-voltage transient protection in electrical circuits using dynamically controlled clamping mechanisms. Electrical circuits are vulnerable to damage from over-voltage transients (or voltage spikes). To protect against these over-voltage transients, devices such as Metal Oxide Varistors (MOVs), Transient Voltage Suppressors (TVS), Gas Discharge Tubes (GDTs), or the like are utilized in electrical circuits. These protection devices operate by limiting excessive voltages and redirecting transient energy away from electrical circuit components.

While MOVs, TVS devices, and GDTs provide effective protection in many cases, there are some challenges related to precision in clamping. For example, MOVs may be configured to activate when input voltage exceeds a clamping threshold. However, the clamping threshold of MOVs can sometimes be higher than the normal operating voltage of the electrical circuit. As a result, a delay in clamping may occur, potentially exposing electrical components to higher voltages before voltage clamping is applied. For example, an MOV with a maximum continuous operating voltage of 75V may have a clamping threshold of 157V, offering limited effectiveness for circuits operating at 48V or 60V. Similarly, TVS devices, known for faster response times, exhibit clamping thresholds that vary with current levels, potentially impacting performance under specific conditions. GDTs, while capable of handling high-energy surges, have slower response times and higher trigger voltages, making them less suitable for applications requiring quick and precise clamping. Traditional protection systems, which often rely on fixed clamping thresholds, may not adapt to changing voltage conditions, leading to scenarios where protection may not be optimized during minor voltage fluctuations or brief surges. Another aspect of conventional protection circuits is the use of static clamping thresholds, which are not adaptable to changing operating conditions or voltage environments. Electrical circuits configured for 48V or 60V operation may encounter over-voltage conditions in some cases, where the protection devices activate too late or may not respond in time due to the wider range clamping voltage range.

In various embodiments, the present disclosure provides an over-voltage transient protection circuit to protect circuit components from voltage spikes while maintaining control over the protection mechanism. For example, the over-voltage transient protection circuit may be configured to monitor an input voltage, detect presence of an over-voltage condition (e.g., voltage spike in the input voltage), and dynamically couple or isolate a clamping element based the over-voltage conditions. In many embodiments, the over-voltage transient protection circuit may include the clamping element, a switching element, and a switch controller. The switching element may be operably coupled in series with the clamping element. Further, the switching element may be controlled by the switch controller to transition between conducting and non-conducting states. In various embodiments, the over-voltage transient protection circuit may monitor a voltage level of the input voltage. For example, the switch controller may include a comparator configured to compare the monitored voltage level with a voltage threshold. If the monitored voltage level exceeds the voltage threshold (e.g., the clamping threshold), the switch controller may control a switching operation of the switching element to transition the switching element from the non-conducting state to the conducting state, thereby establishing a connection between the clamping element and one or more circuit elements of the electrical circuit to dissipate excess energy and limit the voltage within a safe range. In many further embodiments, the switch controller may be further configured to re-isolate the clamping element once the over-voltage condition has subsided, allowing the electrical circuit to return to a normal operating state. This re-isolation may reduce power losses and minimize wear on the clamping element.

In additional embodiments, the over-voltage transient protection circuit may be capable of operating on a configurable clamping threshold. For example, the voltage threshold can be dynamically re-configured (adapted or reset) based on operating conditions such as the monitored voltage level trend over time, load trend, etc. In other words, the voltage threshold may be a configurable parameter that can be dynamically configured (or reset) based on a setting input. In further embodiments, dynamic voltage threshold configuration or adjustment may enable the over-voltage transient protection circuit to optimize clamping performance based on varying conditions, such as changes in the power supply voltage or system load. The ability to dynamically reset or re-configure the voltage threshold may improve the efficiency of protection by ensuring that the clamping element activates only when one or more conditions are satisfied, avoiding power dissipation or damage to components.

In further additional embodiments, the over-voltage transient protection circuit may incorporate a surge tracking and recording mechanism to monitor and log over-voltage events that occur over time. For example, the over-voltage transient protection circuit may include an input voltage monitoring circuit to monitor the voltage level of the input voltage. The monitored voltage level may be transmitted to an external or integrated control logic, via a communication link, for real-time diagnostics, maintenance, scheduling, or failure analysis. Such monitoring and tracking may enhance a system's (e.g., any system using the over-voltage transient protection circuit) overall reliability by providing operators with actionable information regarding the frequency and severity of voltage spikes.

By integrating one or more aspects such as dynamic control of the clamping element, precise voltage clamping, and real-time tracking, the present disclosure may provide enhanced protection for electrical circuits while addressing the limitations of conventional over-voltage transient protection devices. The present disclosure can be applicable in a variety of settings including DC power supply systems, automotive applications, industrial equipment, or the like.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in many embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

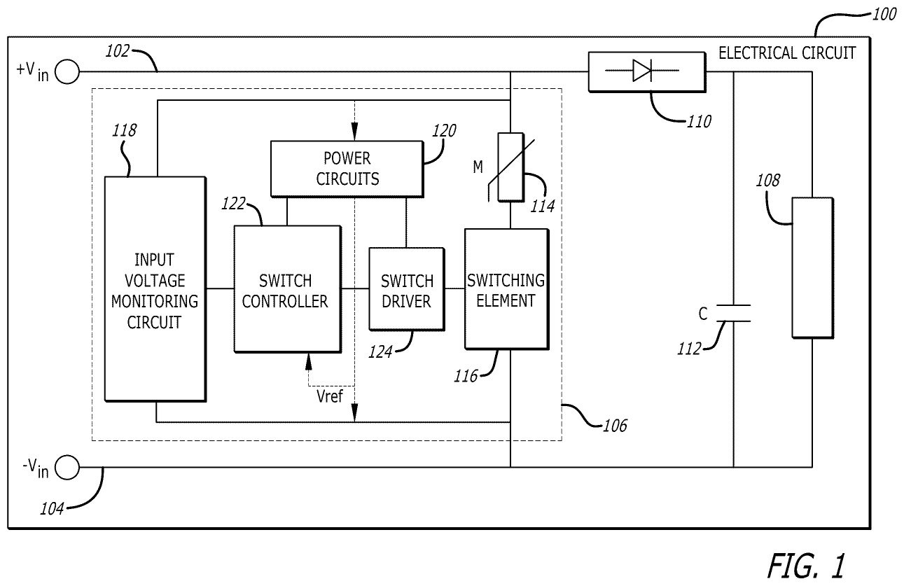

Referring to FIG. 1, a conceptual block diagram of an electrical circuit 100 including an over-voltage transient protection circuit 106 in accordance with various embodiments of the disclosure is shown. In various embodiments, the electrical circuit 100 may be a Direct Current (DC) front-end power supply circuit. Further, the over-voltage transient protection circuit 106 may be configured to protect the electrical circuit 100 from voltage spikes. A voltage spike may refer to a sudden, rapid increase in voltage that may exceed a normal operating level of an electrical circuit. In an example, a voltage spike can last from microseconds to milliseconds. Voltage spikes may include voltage transients, voltage surges, and other types of voltage fluctuations, which may arise from causes such as lightning surges, power contact events, or power induction from adjacent electrical systems or equipment. Voltage spikes can cause damage to circuit components in the absence of adequate protection mechanisms.

In several embodiments, during a normal operating condition of the electrical circuit 100, the over-voltage transient protection circuit 106 may remain inactive or turned OFF, and the electrical circuit 100 may function as intended without interference from the over-voltage transient protection circuit 106. Normal operating condition may refer to, for example, steady-state operating condition, where a voltage level of an input voltage remains within a set nominal range (e.g., less than a voltage threshold) without transient disturbances, over-voltage events, or fault conditions.

In yet various embodiments, the over-voltage transient protection circuit 106 may perform a clamping operation during a voltage spike. The clamping operation may refer to a mechanism by which the over-voltage transient protection circuit 106 may limit the voltage reaching one or more circuit components in the electrical circuit 100 during the voltage spike. In still various embodiments, when the input voltage exceeds the voltage threshold (also referred to as a “clamping voltage”), the over-voltage transient protection circuit 106 may get activated to divert the excess voltage away from the electrical circuit 100, thereby preventing potential damage. The clamping operation may ensure that the voltage supplied to the electrical circuit 100 remains within safe limits (e.g., below the voltage threshold), effectively safeguarding the one or more circuit components from over-voltage conditions.

In many embodiments, the electrical circuit 100 may include a pair of terminals 102, 104 (individually referred to as a “positive terminal +Vᵢₙ 102” and a “negative terminal −Vᵢₙ 104”) and one or more circuit elements coupled between the pair of terminals 102, 104. For the sake of brevity, the one or more circuit elements are collectively illustrated as a load 108 coupled between the pair of terminals 102, 104. In a non-limiting example, the load 108 may include resistive circuit elements, inductive circuit elements, capacitive circuit elements, or other types of electronics components. In several embodiments, an input voltage may be applied across the pair of terminals 102, 104. In an example, the negative terminal −Vᵢₙ 104 may be connected to a ground connection.

In yet many embodiments, the electrical circuit 100 may further include a polarity guard 110 and a capacitor 112. The polarity guard 110 may be a protective device designed to prevent reverse polarity currents or negative voltage spikes in the input voltage from propagating further in the electrical circuit 100. In further embodiments, the polarity guard 110 may include a diode or similar device capable of blocking reverse current flow. In still many embodiments, the polarity guard 110 may be configured to only allow correct polarized voltage to pass to downstream components (e.g., the load 108) of the electrical circuit 100, particularly during voltage transient conditions in the input voltage. In a variety of embodiments, the capacitor 112 may be configured to stabilize the input voltage and filter high-frequency noise. The capacitor 112 may be configured to absorb residual energy during clamping operations. In further embodiments, the capacitor 112 may absorb or filter oscillations or voltage ripples in the input voltage caused by voltage transient events, ensuring smooth and reliable operation of the electrical circuit 100. In some more embodiments, the polarity guard 110 and the capacitor 112 may be coupled between the over-voltage transient protection circuit 106 and the load 108 to function as a polarity protection and ripple filtering stage.

In still various embodiments, the over-voltage transient protection circuit 106 may be coupled between the pair of terminals 102, 104 and to the one or more circuit elements (e.g., the load 108), and may receive the input voltage. In still more embodiments, the over-voltage transient protection circuit 106 may include a clamping element 114 and a switching element 116. The switching element 116 may be coupled in series with the clamping element 114 between the pair of terminals 102, 104. In various embodiments, the clamping element 114 and the switching element 116 may operate in tandem to limit excessive voltage levels in the input voltage. The clamping element 114 may be configured to dissipate excess energy during voltage spikes in the input voltage, protecting the electrical circuit 100 from damage. In various additional embodiments, the clamping element 114 may have a maximum continuous operating voltage that is less (or lower) than a continuous voltage associated with the electrical circuit 100. Continuous voltage associated with an electrical circuit may refer to a steady-state voltage that remains constant over time under normal operating conditions. Continuous voltage may correspond to the voltage level that an electrical circuit (e.g., the electrical circuit 100) maintains during regular operation, as opposed to transient voltages, spikes, or fluctuations. Examples of the clamping element 114 may include, but are not limited to, Metal Oxide Varistors (MOVs), Transient Voltage Suppressors (TVS), or Gas Discharge Tubes (GDTs). In a non-limiting example, the clamping element 114 may be a clamping voltage MOV. Further, the switching element 116 may be any semiconductor switching control device, such as a switching Metal-Oxide-Semiconductor Field-Effect Transistor (MOSFET) or Insulated Gate Bipolar Transistor (IGBT). The switching element 116 may be configured to isolate the clamping element 114 during the normal operating condition of the electrical circuit 100 from the one or more circuit elements (e.g., the load 108) and establish a connection between the clamping element 114 and the one or more circuit elements (e.g., the load 108) during transient conditions (e.g., voltage spike conditions in the input voltage).

In still many embodiments, the switching element 116 may be operable in a conducting state or a non-conducting state based on a voltage spike being present or absent in the input voltage, respectively. In the non-conducting state, the switching element 116 may isolate the clamping element 114 from the one or more circuit elements (e.g., the load 108), and in the conducting state, the switching element 116 may establish a connection between the clamping element 114 and the one or more circuit elements (e.g., the load 108).

In many further embodiments, the over-voltage transient protection circuit 106 may further include an input voltage monitoring circuit 118 and power circuits 120. In additional embodiments, the over-voltage transient protection circuit 106 may include a switch controller 122 coupled to the input voltage monitoring circuit 118, and a switch driver 124 coupled to the switch controller 122. In an example, the switch driver 124 may couple the switch controller 122 to the switching element 116.

In still more embodiments, the input voltage monitoring circuit 118 may be a circuit component that may be configured to continuously or periodically monitor the input voltage to detect any over-voltage conditions (for example, a voltage spike) in the input voltage. In many examples, the input voltage monitoring circuit 118 may be coupled between the pair of terminals 102, 104 parallel to the clamping element 114 and the switching element 116. In various additional embodiments, the input voltage monitoring circuit 118 may include one or more components such as sensing components, voltage dividers, Analog-to-Digital Converters (ADCs) or specialized voltage sensors, to measure the input voltage accurately.

In a number of embodiments, the switch controller 122 may be configured to process monitored voltage data received from the input voltage monitoring circuit 118. For example, the switch controller 122 may be configured to detect whether the voltage spike is present in the input voltage based on a voltage level of the input voltage and the voltage threshold. In examples, the voltage threshold may represent a maximum allowable voltage level for safe operation of the electrical circuit 100. The voltage threshold can be pre-configured. For example, the voltage threshold may be set during manufacturing of the electrical circuit 100 to match specifications of the one or more circuit components. The voltage spike may be detected as absent in the input voltage based on the voltage level of the input voltage being less than the voltage threshold. The voltage spike may be detected as present in the input voltage based on the voltage level of the input voltage exceeding the voltage threshold. The switch controller 122 may utilize the monitored voltage data to determine an operational state of the over-voltage transient protection circuit 106, potentially triggering protective actions, such as controlling an operation of the switching element 116.

In still further embodiments, the switch controller 122 may be configured to control a switching operation of the switching element 116 based on the detection of whether the voltage spike is present in the input voltage or not. The switching operation of the switching element 116 may include operating the switching element 116 in the non-conducting state based on the detection that the voltage spike is absent in the input voltage. Further, the switching operation of the switching element 116 may include causing the switching element 116 to transition from the non-conducting state to the conducting state in response to the detection that the voltage spike is present in the input voltage. Furthermore, controlling the switching operation of the switching element 116 may include operating the switching element 116 in the conducting state at least until the voltage spike in the input voltage persists. Additionally, controlling the switching operation of the switching element 116 may include causing the switching element 116 to transition from the conducting state to the non-conducting state in response to cessation of the voltage spike in the input voltage. In other words, the switch controller 122 may determine when to activate (conducting state operation) or deactivate (non-conducting state operation) the switching element 116.

In various further embodiments, the switch driver 124 may be configured to receive one or more signals from the switch controller 122, based on the detection of whether the voltage spike is present in the input voltage or not, to control (e.g., activate or deactivate) the switching element 116 accordingly. In yet many embodiments, the switch driver 124 may ensure that the switching element 116 operates reliably, even under rapidly changing input voltage conditions. Further, the power circuits 120 may be connected to the positive terminal +Vᵢₙ 102 to supply power to various components, such as the switch controller 122 and the switch driver 124) of the over-voltage transient protection circuit 106 to ensure proper operation. In an example embodiment, the power circuits 120 may be configured to provide reference operating voltage Vref to the switch controller 122 and the input voltage monitoring circuit 118.

In many further embodiments, during the normal operating condition of the electrical circuit 100, the clamping element 114 may be normally isolated from the one or more circuit elements (for example, the load 108, the polarity guard 110, and the capacitor 112) of the electrical circuit 100. In many examples, the clamping element 114 being isolated from the one or more circuit elements may refer to the clamping element 114 being disconnected or not electrically connected to the one or more circuit elements under normal operating conditions. The clamping element 114 may remain isolated from the one or more circuit elements until needed, for example, until a voltage spike is detected in the input voltage, to protect the electrical circuit 100. In still yet various embodiments, when the over-voltage transient protection circuit 106 detects a voltage spike in the input voltage, the switching element 116 may get transitioned from the non-conducting state to the conducting state to establish a connection between the clamping element 114 and the one or more circuit elements. In several embodiments, the clamping element 114 may be configured to handle excess voltage by dissipating or diverting energy (for example, excess voltage) away from the one or more circuit elements. Once the connection is established, the clamping element 114 may become a part of an electrical path of the electrical circuit 100, limiting the input voltage to a safe level. In yet many additional embodiments, upon detecting a cessation of the voltage spike in the input voltage, the switching element 116 may get transitioned from the conducting state to the non-conducting state to re-isolate the clamping element 114 from the one or more circuit elements. In many examples, the clamping element 114 being re-isolated from the one or more circuit elements may refer to the clamping element 114 being again disconnected or not electrically connected to the one or more circuit elements after the voltage spike ceases.

In many additional embodiments, the electrical circuit 100 may be configured to receive the input voltage from an external source. The external source may provide voltage for the operation of the electrical circuit 100. By way of non-limiting example, the external source may be a DC power source, such as a battery, a rectified AC power source, or any other suitable voltage source. In various further embodiments, the pair of terminals 102, 104 may be configured to receive the input voltage from the external source. In yet numerous embodiments, the input voltage monitoring circuit 118 may monitor the input voltage received at the pair of terminals 102, 104. In examples, the monitoring may occur at regular intervals (periodic monitoring) or continuously for more dynamic and immediate detection of voltage variations. In many further embodiments, the input voltage monitoring circuit 118 may be configured to monitor a voltage level of the input voltage and transmit the monitored voltage level to the switch controller 122.

In still numerous embodiments, the switch controller 122 may be configured to receive the monitored voltage level from the input voltage monitoring circuit 118 and detect whether the voltage spike is present in the input voltage. For example, the switch controller 122 may compare the voltage level of the input voltage with the voltage threshold to detect whether the voltage spike is present in the input voltage. If the voltage level exceeds the voltage threshold, the switch controller 122 may detect the voltage spike to be present in the input voltage. If the voltage level does not exceed the voltage threshold, the switch controller 122 may detect the voltage spike to be absent in the input voltage. In several embodiments, the switch controller 122 may control the switching operation of the switching element 116, using the switch driver 124, based on the detection of whether the voltage spike is present in the input voltage.

In several additional embodiments, the switch controller 122 may trigger the switch driver 124 to activate the switching element 116 when the voltage spike is detected to be present in the input voltage. Upon being activated, the switching element 116 may transition from the non-conducting state to the conducting state. In an example, the switch controller 122 may generate a control signal to activate the switching element 116, causing the switching element 116 to transition from the non-conducting state to the conducting state. In the conducting state, the switching element 116 may establish the connection between the clamping element 114 and the one or more circuit elements. When the connected clamping element 114 receives the input voltage with the voltage spike rises above the voltage threshold, the clamping element 114 gets activated due to the excess voltage surpassing the safe operating limit. The clamping element 114 may then effectively divert or absorb the excessive voltage, ensuring that the excessive voltage does not reach the one or more circuit elements. The clamping element 114 may operate by redirecting the excess voltage to a ground or a safe dissipation path, thus protecting the electrical circuit 100 from damage. As a result, the voltage in the electrical circuit 100 is limited to a safe level, which prevents potential damage from sustained high voltages.

In further embodiments, the input voltage monitoring circuit 118 may monitor the input voltage to detect a cessation of the voltage spike in the input voltage. Upon detecting the cessation of the voltage spike, the input voltage monitoring circuit 118 may send an indication to the switch controller 122. The switch controller 122 may trigger the switch driver 124 to deactivate the switching element 116. Upon getting deactivated, the switching element 116 may transition from the conducting state to the non-conducting state. Thus, the switching element 116 may re-isolate the clamping element 114 from the one or more circuit elements in response to detecting the cessation of the voltage spike in the input voltage

In still numerous embodiments, the over-voltage transient protection circuit 106 may protect the electrical circuit 100 from positive over-voltage transients. In an example, the electrical circuit 100 may operate with an input voltage of 72V under normal operating conditions. When a positive over-voltage transient occurs, and the input voltage may exceed 72V, a voltage spike may be detected. The switch controller 122 may compare the voltage level with a voltage threshold of 77V. Upon detection of the voltage level exceeding the predefined voltage threshold (e.g., in response to the voltage spike), the switch controller 122 may activate the switching element 116 (e.g., transition the switching element 116 from the non-conducting state to the conducting state), which establishes a connection between the clamping element 114 and the one or more circuit elements. The clamping element 114 may then clamp the voltage at 77V, diverting or dissipating the excess energy, and preventing the voltage from rising higher than this safe limit. As a result, the electrical circuit 100 remains protected from over-voltage damage, as the circuit voltage is confined to the clamped 77V level. Once the over-voltage condition subsides and the input voltage falls back below the voltage threshold, the switch controller 122 may deactivate the switching element 116 (e.g., transition the switching element 116 from the conducting state to the non-conducting state), isolating the clamping element 114 from the one or more circuit elements. This mechanism ensures dynamic over-voltage protection by continuously monitoring the input voltage and responding to transient over-voltage conditions in real-time, safeguarding circuit components from damage caused by excess voltage.

In still yet additional embodiments, when a negative over-voltage transient occurs, and the input voltage may exceed a forward voltage (for example, around 1V) of the switching element 116, the clamping element 114 may clamp the transient voltage. In the example, clamping voltage (e.g., the voltage threshold) of the clamping element 114 may be 77V. Accordingly, the negative transient voltage may be clamped below −78VDC, which is the sum of the forward voltage of the switching element 116 and the clamping voltage. As a result, the transient voltage does not affect downstream components (e.g., the load 108) of the electrical circuit 100. The voltage across the downstream components may be maintained by the capacitor 112, and remains unaffected because the duration of the transient voltage may be short, in the range of tens of microseconds.

By leveraging the switching operation of the switching element 116, the clamping element 114 is selectively allowed to receive the input voltage, for example, only at the time of voltage spike in the input voltage. Such implementation allows the use of the clamping element 114 that has the maximum continuous operating voltage lower than the continuous voltage associated with the electrical circuit 100, enabling precise control over clamping voltage as compared to conventional circuits.

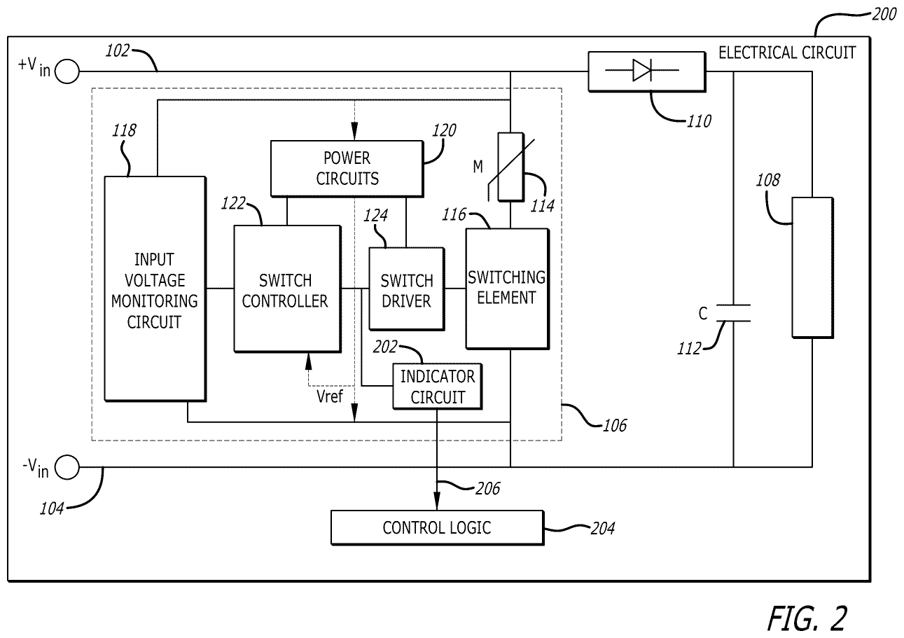

Although a specific embodiment of an electrical circuit including an over-voltage transient protection circuit suitable for carrying out the various steps, processes, methods, and operations described herein is discussed with respect to FIG. 1, any of a variety of systems and/or processes may be utilized in accordance with embodiments of the disclosure. For example, in yet many additional embodiments, the over-voltage transient protection circuit 100 may include a control logic to track one or more instances of voltage spikes in the input voltage. The elements depicted in FIG. 1 may also be interchangeable with other elements of FIGS. 2-8 as required to realize a particularly desired embodiment.

Referring to FIG. 2, a conceptual block diagram of the over-voltage transient protection circuit 106 that additionally provides voltage spike indication in accordance with various embodiments of the disclosure is shown. In various embodiments, an electrical circuit 200, shown in FIG. 2, may be equivalent to the electrical circuit 100 of FIG. 1 with an exception that the electrical circuit 200 may additionally include an indicator circuit 202, a control logic 204, and a communication link 206, enabling enhanced functionality for monitoring, tracking, and recording over-voltage events. In yet various embodiments, the indicator circuit 202 may be integrated into the over-voltage transient protection circuit 106. The electrical circuit 200 may also include the pair of terminals 102, 104, the over-voltage transient protection circuit 106, the load 108, the polarity guard 110, and the capacitor 112. In addition to the indicator circuit 202, the over-voltage transient protection circuit 106 may include the clamping element 114, the switching element 116, the input voltage monitoring circuit 118, the power circuits 120, the switch controller 122, and the switch driver 124. These components cooperate to detect over-voltage conditions, activate the clamping mechanism, and protect the load 108.

In further embodiments, the indicator circuit 202 may be electrically coupled to the switching element 116 and configured to generate an indication based on a voltage spike being present in the input voltage. For example, the indicator circuit 202 may generate a signal whenever the switching element 116 transitions from a conducting state to a non-conducting state, or from a non-conducting state to a conducting state. This signal may serve as the indication of the presence of the voltage spike in the input voltage. In more embodiments, the signal may be visual, such as illuminating a Light Emitting Diode (LED), or digital for further electronic processing. The indicator circuit 202 may enable the over-voltage transient protection circuit 106 to provide immediate awareness of over-voltage events.

In many embodiments, the control logic 204 may be electrically coupled to the indicator circuit 202. The control logic 204 may be configured to process the signal or indication generated by the indicator circuit 202 and track over-voltage event data. For example, the control logic 204 may track one or more instances of voltage spikes in the input voltage, based on the indication generated. Additionally, the control logic 204 may track the duration of over-voltage events and related information. In many further embodiments, the control logic 204 may store the tracked data in a memory element, enabling long-term monitoring and analysis.

In yet many embodiments, the communication link 206 may be coupled to both the indicator circuit 202 and the control logic 204. The communication link 206 may facilitate the transmission of over-voltage event data to the control logic 204. The communication link 206 may be implemented as a wired interface in some embodiments, while in others, it may be a wireless interface, enabling remote access and diagnostics of the electrical circuit 200.

In numerous embodiments, the operation of the electrical circuit 200 may proceed similarly to the operation described for the electrical circuit 100 in FIG. 1. The input voltage monitoring circuit 118 may monitor the voltage level of the input voltage and transmit the monitored voltage level to the switch controller 122. The switch controller 122 may detect whether a voltage spike is present in the input voltage. Upon detecting the voltage spike, the switch controller 122 may cause the switching element 116 to transition from the non-conducting state to the conducting state. In further embodiments, when the switching element 116 transitions from the non-conducting state to the conducting state, the indicator circuit 202 may generate a signal to indicate that an over-voltage event has occurred. In additional embodiments, the signal may illuminate an LED or trigger an electronic output for external processing. Additionally, the signal may be transmitted to the control logic 204 via the communication link 206. The control logic 204 may process the signal and record relevant data regarding the over-voltage event. Upon detecting the cessation of the voltage spike, the switch controller 122 may cause the switching element 116 to transition from the conducting state back to the non-conducting state, isolating the clamping element 114 from the one or more circuit elements and allowing normal operation to resume. The indicator circuit 202 may generate another signal, and the control logic 204 may record and storage cessation of voltage spike event and related data.

In various additional embodiments, an output pin may be associated with the indicator circuit 202 that may toggle from a low to a high state (or vice versa), depending on the detection of an over-voltage event. An external microcontroller, for example, the control logic 204 may receive and record the pin flipping along with a timestamp, enabling the tracking of surge events over time. Such data log may provide insights into the occurrence of over-voltage events, such as how many surges occurred and when, at specific system installation locations. Such data may be helpful for system debugging (e.g., identifying potential causes of system resets or failures) and can serve as reference data for improving surge protection designs at those specific locations.

Although a specific embodiment of an over-voltage transient protection circuit that additionally provides voltage spike indication suitable for carrying out the various steps, processes, methods, and operations described herein is discussed with respect to FIG. 2, any of a variety of systems and/or processes may be utilized in accordance with embodiments of the disclosure. For example, in still many embodiments, although the control logic 204 is shown to be external to the over-voltage transient protection circuit 106, the control logic 204 may be integrated into the over-voltage transient protection circuit 106 or can also be provided as a standalone component that is external to the electrical circuit 200. The elements depicted in FIG. 2 may also be interchangeable with other elements of FIGS. 1 and 3-8 as required to realize a particularly desired embodiment.

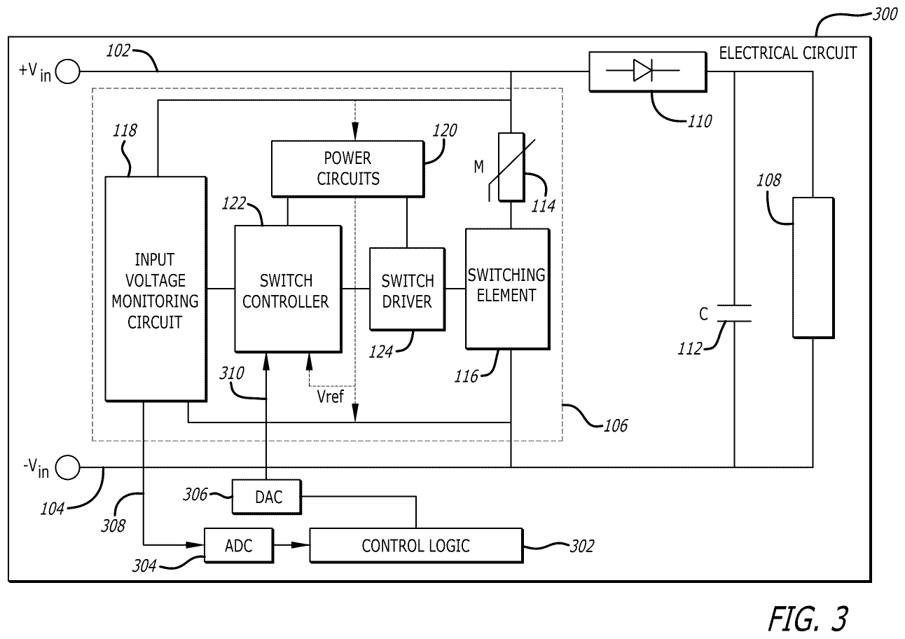

Referring to FIG. 3, a conceptual block diagram of the over-voltage transient protection circuit 106 that operates based on a dynamically configurable voltage threshold in accordance with various embodiments of the disclosure is shown. In various embodiments, an electrical circuit 300, shown in FIG. 3, may be equivalent to the electrical circuit 100 of FIG. 1 or the electrical circuit 200 of FIG. 2 with an exception that the electrical circuit 300 may additionally include a control logic 302, which may allow the electrical circuit 300 to dynamically adjust voltage threshold to trigger a voltage clamping operation based on real-time operating conditions. In more embodiments, the electrical circuit 300 may also include an Analog-to-Digital Converter (ADC) 304 and Digital-to-Analog Converter (DAC) 306. The electrical circuit 300 may also include the pair of terminals 102, 104, the over-voltage transient protection circuit 106, the load 108, the polarity guard 110, and the capacitor 112. The over-voltage transient protection circuit 106 may include the clamping element 114, the switching element 116, the input voltage monitoring circuit 118, the power circuits 120, the switch controller 122, and the switch driver 124. These components cooperate to detect over-voltage conditions, activate the clamping mechanism, and protect the load 108.

In many embodiments, the control logic 302 may be electrically coupled to the switch controller 122 through the DAC 306. Further, the control logic 302 may be electrically coupled to the input voltage monitoring circuit 118 through the ADC 304. In a variety of embodiments, the ADC 304 may receive a monitored voltage level 308 from the input voltage monitoring circuit 118. The ADC 304 may be configured to convert the monitored voltage level 308 from an analog format to a digital format. In still various embodiments, the ADC 304 may provide the digital format of the monitored voltage level 308 to the control logic 302. The control logic 302 may be configured to determine a voltage threshold based on the monitored voltage level 308 received over a time period. As a result, the voltage threshold can be dynamically adjusted (or configured or reset).

In further embodiments, the control logic 302 may generate a setting input 310 based on the determined voltage threshold. Further, the control logic 302 may provide the setting input 310 to the DAC 306. The DAC 306 may be configured to convert the setting input 310 from a digital format to an analog format. Further, the DAC 306 may provide the digital format of the setting input 310 to the switch controller 122. As a result, the switch controller 122 may be configured with the determined voltage threshold. In several embodiments, the switch controller 122 may be configured to receive the setting input 310 for the voltage threshold from the control logic 302, for example, via the DAC 306. In examples, the voltage threshold may be configurable based on the setting input 310.

In many further embodiments, the control logic 302 may ensure that the voltage threshold is set optimally for the current operating conditions. For example, in an environment where the electrical circuit 300 operates at 48V, the control logic 302 may be configured to determine the voltage threshold of 65V. In further embodiments, if the electrical circuit 300 operates at 60V, the voltage threshold may be dynamically reset to, for example, 77V. Such dynamic re-configuration or setting may provide precise protection to the specific voltage requirements, minimizing unnecessary power dissipation while ensuring effective over-voltage protection.

In numerous embodiments, the over-voltage transient protection circuit 106 may include multiple switching elements 116 coupled to the switch driver 124 and the clamping element 114. These multiple switching elements can be connected in parallel with respect to each other and are in series connection with the clamping element 114. Since the voltage threshold can be dynamically reconfigured, the clamping operation of the clamping element 114 can be triggered at different voltage levels and for each voltage threshold a different amount of excess voltage gets dissipated via the clamping element 114. To accommodate these variations, switching elements with different voltage ratings (e.g., 40V, 60V, 80V, etc) may be utilized, ensuring that the appropriate switching element is engaged to match specific clamping requirement at each voltage threshold. In such embodiments, the switch driver 124 may select one of the multiple switching elements depending upon a control signal received from the switch controller 122.

Although a specific embodiment of an over-voltage transient protection circuit that operates based on a dynamically configurable voltage threshold suitable for carrying out the various steps, processes, methods, and operations described herein is discussed with respect to FIG. 3, any of a variety of systems and/or processes may be utilized in accordance with embodiments of the disclosure. For example, in many additional embodiments, although it is shown that the ADC 304 and the DAC 306 may be implemented externally to the control logic 302, in various embodiments, functionality of the ADC 304 and the DAC 306 may be implemented within the control logic 302. The elements depicted in FIG. 3 may also be interchangeable with other elements of FIGS. 1-2 and 4-8 as required to realize a particularly desired embodiment.

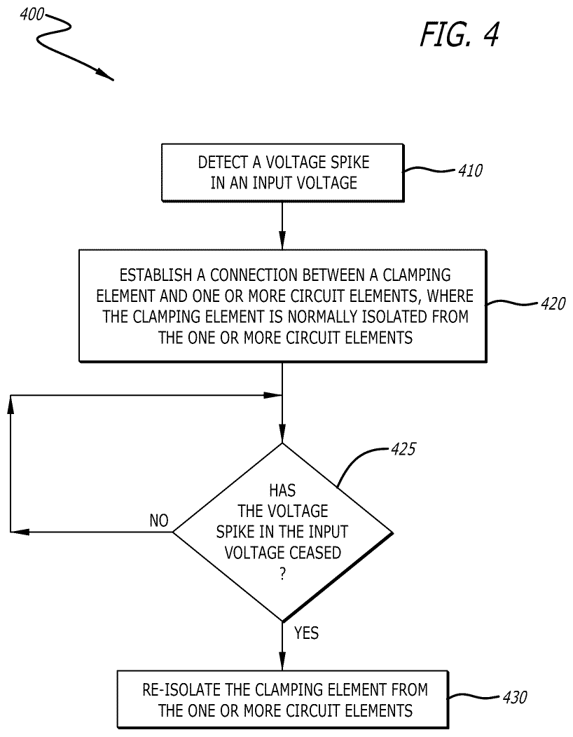

Referring to FIG. 4, a flowchart depicting a process 400 for protecting an electrical circuit from a voltage spike in an input voltage in accordance with various embodiments of the disclosure is shown. In a variety of embodiments, the process 400 may detect a voltage spike in the input voltage (block 410). In several embodiments, the process 400 may detect the voltage spike based on a voltage level of the input voltage exceeding a voltage threshold. For example, if an input voltage of an electrical circuit is nominally 72V, a voltage threshold may be set at 75V to protect the electrical circuit from voltage spikes. The process 400 may monitor the input voltage, and if the voltage level of the input voltage exceeds 75V, the process 400 may detect a voltage spike.

In further embodiments, the process 400 may establish a connection between a clamping element and one or more circuit elements of the electrical circuit, where the clamping element is normally isolated from the one or more circuit elements (block 420). In many examples, the clamping element being isolated from the one or more circuit elements may refer to the clamping element being disconnected or not electrically connected to the one or more circuit elements under normal operating conditions. Normal operating conditions may refer to, for example, steady-state operating conditions, where the voltage level of the input voltage remains within a set nominal range (e.g., less than the voltage threshold) without transient disturbances, over-voltage events, or fault conditions. The clamping element may remain isolated from the one or more circuit elements until needed, for example, until a voltage spike is detected. In several embodiments, the process 400 may utilize a switching element, coupled in series with the clamping element, to establish a connection between the clamping element and the one or more circuit elements or to isolate the clamping element from the one or more circuit elements. The clamping element may be configured to handle excess voltage by dissipating or diverting energy (for example, excess voltage) away from the one or more circuit elements. Once the connection is established, the clamping element may become a part of an electrical path of the electrical circuit, limiting the input voltage to a safe level.

In more embodiments, the process 400 may determine whether the voltage spike in the input voltage has ceased (block 425). In various embodiments, the process 400 may continuously monitor the voltage level of the input voltage. For example, the process 400 may compare the voltage level of the input voltage with the voltage threshold. If it is determined that the voltage level drops below the voltage threshold and remains less than the voltage threshold for a configured time period, the process 400 may determine that the voltage spike in the input voltage has ceased. For example, if the voltage threshold is 75V and the voltage level drops below 75V and remains less than 75V for more than 1 millisecond, the process 400 may determine that the voltage spike has ceased.

In additional embodiments, if it is determined that the voltage spike in the input voltage has not ceased, the process 400 may maintain the connection between the clamping element and the one or more circuit elements and continue to monitor the voltage level of the input voltage (block 425). Thus, ensuring continuous protection of the electrical circuit during prolonged over-voltage conditions.

In many additional embodiments, if it is determined that the voltage spike in the input voltage has ceased, the process 400 may re-isolate the clamping element from the one or more circuit elements (block 430). In many further embodiments, the process 400 may re-isolate the clamping element from the one or more circuit elements in response to detecting a cessation of the voltage spike in the input voltage. In several embodiments, the process 400 may utilize the switching element to isolate or disconnect the clamping element from the electrical circuit based on cessation of the voltage spike in the input voltage. Re-isolating the clamping element may allow the electrical circuit to resume normal operation without energy dissipation. In yet further embodiments, the re-isolation of the clamping element may involve resetting internal monitoring data, such as voltage history or event logs, to prepare the electrical circuit for future over-voltage events. In still further embodiments, the re-isolation may be delayed for the configured time period after the voltage spike ceases, allowing the electrical circuit to confirm the stability of the input voltage before disconnecting or re-isolating the clamping element. Thus, preventing premature re-isolation during transient fluctuations.

Although a specific embodiment for protecting an electrical circuit from voltage spikes in an input voltage suitable for carrying out the various steps, processes, methods, and operations described herein is discussed with respect to FIG. 4, any of a variety of systems and/or processes may be utilized in accordance with embodiments of the disclosure. In numerous embodiments, the voltage threshold may be configurable, for example, based on operating environment of the electrical circuit, protection requirements, temperature conditions, voltage source variations, or the like. The elements depicted in FIG. 4 may also be interchangeable with other elements of FIGS. 1-3 and 5-8 as required to realize a particularly desired embodiment.

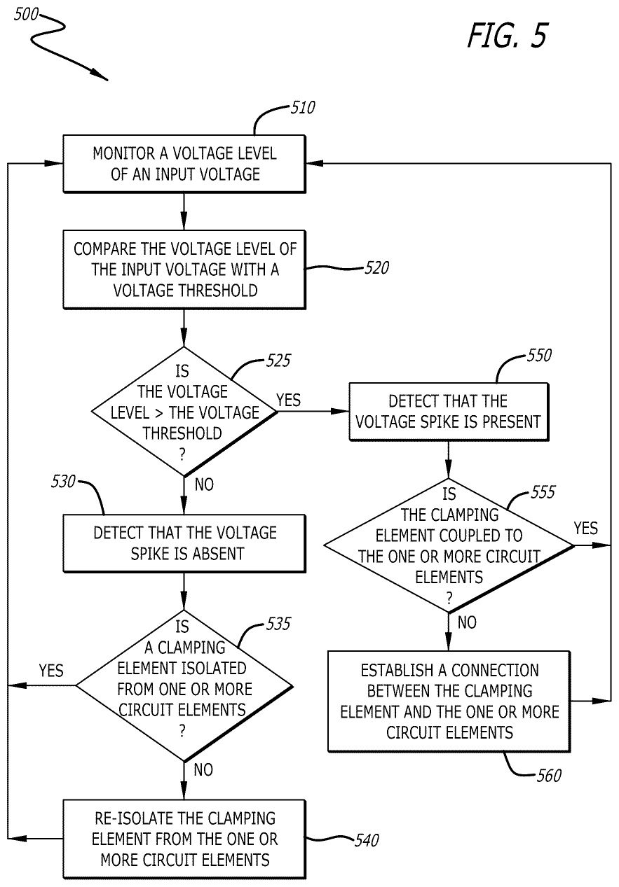

Referring to FIG. 5, a flowchart depicting a process 500 for protecting an electrical circuit against voltage spikes in an input voltage in accordance with various embodiments of the disclosure is shown. In a number of embodiments, the process 500 may monitor a voltage level of an input voltage (block 510). In various embodiments, the process 500 may continuously monitor the voltage level of the input voltage received by the electrical circuit. For example, the process 500 may track fluctuations in the input voltage to detect any changes or irregularities in the voltage level, ensuring that any deviations from the normal voltage level are promptly identified.

In further embodiments, the process 500 may compare the voltage level of the input voltage with a voltage threshold (block 520). In various embodiments, the voltage threshold may be pre-configured. For example, the voltage threshold may be set during manufacturing of the electrical circuit to match specifications of circuit components. In various additional embodiments, the voltage threshold may be configurable, based on factors such as operating temperature, system load, or historical data on over-voltage events. For example, the voltage threshold may be configured using a setting input, allowing an external or integrated system to modify the voltage threshold. This flexibility may ensure that a protection mechanism (e.g., an over-voltage transient protection circuit) for the electrical circuit is adaptable to different operating environments and system requirements.

In many embodiments, the process 500 may determine whether the monitored voltage level exceeds the voltage threshold (block 525). In yet various embodiments, the process 500 may determine whether the monitored voltage level exceeds the voltage threshold to detect if a voltage spike is present the input voltage. A voltage spike may refer to a rapid increase in voltage that may exceed a normal operating level of an electrical circuit. The voltage spike can last from microseconds to milliseconds. Voltage spikes may include voltage transients and other types of voltage fluctuations, which may arise from causes such as lightning surges, power contact events, or power induction from adjacent electrical systems or equipment. Voltage spikes can cause damage to circuit components in an absence of adequate protection mechanisms.

In a variety of embodiments, if it is determined that the monitored voltage level does not exceed the voltage threshold, the process 500 may detect that the voltage spike is absent in the input voltage (block 530). In other word, the voltage spike may be detected as absent in the input voltage based on the voltage level of the input voltage being less than the voltage threshold. For example, if the voltage threshold is set at 75V and the monitored voltage level remains consistently below 75V, the process 500 may detect that the voltage spike is absent in the input voltage. This may indicate that the input voltage is within the normal operating range and no corrective/protective action is triggered.

In many further embodiments, upon detecting that the voltage spike is absent in the input voltage, the process 500 may determine if a clamping element is isolated from one or more circuit elements of the electrical circuit (block 535). For example, if the voltage spike is absent, the clamping element may no longer be required to protect the electrical circuit. Therefore, it may be beneficial to determine if the clamping element is already isolated from the circuit elements or not. Isolating the clamping element may ensure that the electrical circuit can resume normal operation without energy dissipation or interference from the clamping element, which may otherwise remain active. This may also prevent any degradation of the clamping element, as the clamping element is only required to be operational during voltage spikes.

In further embodiments, if it is determined that the clamping element is isolated from the one or more circuit elements of the electrical circuit, the process 500 may continue to monitor the voltage level of the input voltage (block 510). In more embodiments, if it is determined that the clamping element is not isolated from the one or more circuit elements of the electrical circuit, the process 500 may re-isolate the clamping element from the one or more circuit elements (block 540). In examples, the process 500 may re-isolate the clamping element from the one or more circuit elements to ensure that the electrical circuit resumes normal operation without energy loss, interference, or potential damage caused by the continuous operation of the clamping element. Additionally, the process 500 may re-isolate the clamping element from the one or more circuit elements to prevent unnecessary wear or degradation of the clamping element, ensuring its longevity and readiness for future over-voltage events. Subsequently, the process 500 may continue to monitor the voltage level of the input voltage (block 510).

In still more embodiments, if it is determined that the monitored voltage level exceeds the voltage threshold, the process 500 may detect that the voltage spike is present in the input voltage (block 550). For example, if the voltage threshold is set at 75V and the monitored voltage reaches 80V (e.g., exceeds the voltage threshold), the process 500 may detect that a voltage spike has occurred in the input voltage. The detection of the voltage spike may indicate that the input voltage has deviated from a normal range, and the process 500 may trigger protective actions, such as activating a clamping element, to prevent potential damage to circuit components of the electrical circuit.

In yet more embodiments, the process 500 may determine whether the clamping element is coupled to the one or more circuit elements (block 555). For example, the process 500 may check if the clamping element is coupled to the circuit elements in order to provide protection against over-voltage conditions. The determination may ensure that the protection mechanism is in place before the electrical circuit is exposed to any over-voltage risks.

In many additional embodiments, upon determining that the clamping element is coupled to the one or more circuit elements, the process 500 may continue to monitor the voltage level of the input voltage (block 510). The process 500 may continue to monitor the voltage level to detect any further voltage spikes that could indicate additional over-voltage conditions. Such continuous monitoring may ensure that the electrical circuit remains protected, without interruption, throughout the duration of the voltage monitoring process.

In yet further embodiments, upon determining that the clamping element is not coupled to the one or more circuit elements, the process 500 may establish a connection between the clamping element and the one or more circuit elements of the electrical circuit (block 560). In several embodiments, the process 500 may cause a switching element, coupled in series with the clamping element, to transition from a non-conducting state to a conducting state in response to the detection of a voltage spike in the input voltage. In the conducting state, the switching element may establish the connection between the clamping element and the one or more circuit elements. In still yet more embodiments, the process 500 may generate a control signal to activate the switching element and transition the switching element from the non-conducting state to the conducting state in response to the voltage spike. In an example, the electrical circuit may operate at a normal voltage of 72V, and the voltage threshold for triggering the clamping element may be set at 77V. When the input voltage rises above the threshold of 77V, for example to 80V, indicating the presence of a voltage spike, the control signal may be generated. The control signal may cause the switching element to transition from the non-conducting state to the conducting state. In the conducting state, the switching element may establish the electrical connection between the clamping element and the circuit elements. Once the connection is made, the clamping element may become active and begin to clamp the voltage. For example, the clamping element may divert the excess voltage away from the circuit elements. In this case, the clamping element may clamp the voltage from the surge of 80V to a safe level around the threshold of 77V. Such clamping may protect the circuit elements from the potentially damaging higher voltage of 80V.

In still various embodiments, once the connection between the clamping element and one or more circuit elements is established, the process 500 may continue to monitor the voltage level of the input voltage (block 510). The process 500 may continue to monitor the voltage level to detect any further voltage spike that could indicate additional over-voltage conditions. This ensures that the electrical circuit remains continuously protected, without interruption, throughout the duration of the voltage monitoring process. According to further embodiments, resume monitoring of the voltage level of the input voltage once the voltage spike ceases.

Although a specific embodiment for protecting an electrical circuit against voltage spikes in an input voltage suitable for carrying out the various steps, processes, methods, and operations described herein is discussed with respect to FIG. 5, any of a variety of systems and/or processes may be utilized in accordance with embodiments of the disclosure. For example, in numerous embodiments, when the voltage spike ceases and the input voltage drops back below the voltage threshold, the switching element may be deactivated via a control signal, transitioning the switching element back to the non-conducting state from the conducting state. As a result, the clamping element is re-isolated from the electrical circuit. The elements depicted in FIG. 5 may also be interchangeable with other elements of FIGS. 1-4 and 6-8 as required to realize a particularly desired embodiment.

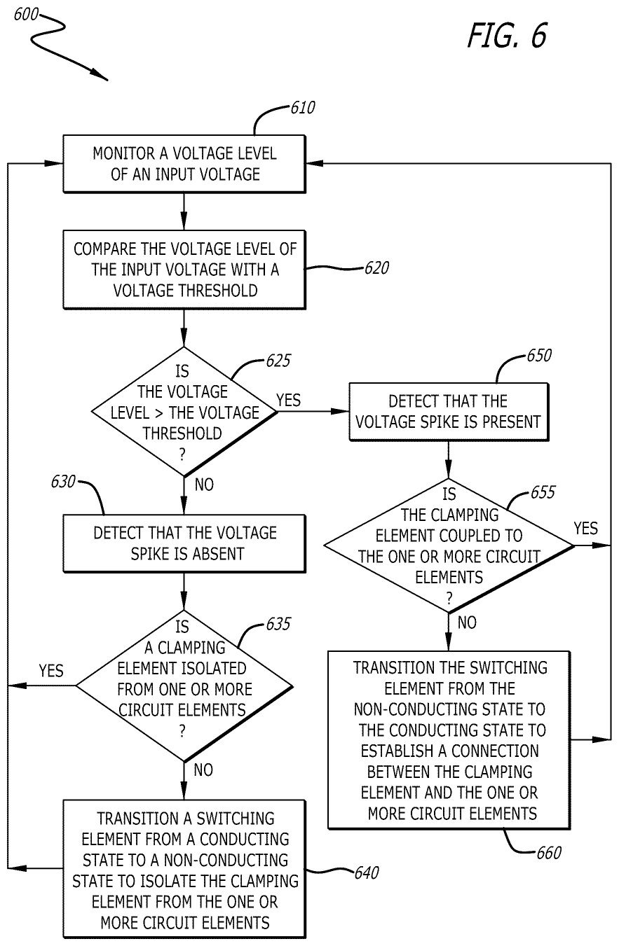

Referring to FIG. 6, a flowchart depicting a process 600 for protecting an electrical circuit against voltage spikes in an input voltage using an over-voltage transient protection circuit in accordance with various embodiments of the disclosure is shown. In a number of embodiments, the process 600 may monitor a voltage level of an input voltage (block 610). In various embodiments, the process 600 may continuously or periodically, based upon system requirements, monitor the voltage level of the input voltage of the electrical circuit. For example, the process 600 may track fluctuations in the input voltage to detect any changes or irregularities in the voltage level, ensuring that any deviations from the normal voltage level are promptly identified.

In further embodiments, the process 600 may compare the voltage level of the input voltage with a voltage threshold (block 620). In various embodiments, the voltage threshold may be pre-configured or preset. For example, the voltage threshold may be set during manufacturing of the electrical circuit to match the specifications of circuit components. In various additional embodiments, the voltage threshold may be configurable, based on factors such as operating temperature, system load, or historical data on over-voltage events. For example, the voltage threshold may be configured using a setting input, allowing an external system to modify the voltage threshold. This flexibility may ensure that the protection mechanism (e.g., the over-voltage transient protection circuit) for the electrical circuit is adaptable to different operating environments and system requirements.

In many embodiments, the process 600 may determine whether the monitored voltage level exceeds the voltage threshold (block 625). In various embodiments, the process 600 may determine whether the monitored voltage level exceeds the voltage threshold to detect if a voltage spike is present the input voltage. Voltage spikes may include voltage transients and other types of voltage fluctuations that exceed a normal operating level of the electrical circuit. Voltage spikes can cause damage to circuit components in the absence of adequate protection mechanisms. The determination may involve identifying whether the duration or magnitude of the voltage spike satisfies one or more predetermined conditions, such as exceeding the voltage threshold for the configured time period.

In a variety of embodiments, if it is determined that the monitored voltage level does not exceed the voltage threshold, the process 600 may detect that the voltage spike is absent in the input voltage (block 630). For example, if the voltage threshold is set at 75V and the monitored voltage level remains consistently below that voltage threshold, the process 600 may detect that the voltage spike is absent in the input voltage.

In many further embodiments, upon detecting that the voltage spike is absent in the input voltage, the process 600 may determine if a clamping element is isolated from one or more circuit elements of the electrical circuit (block 635). For example, if the voltage spike is absent, the clamping element may no longer be required to protect the electrical circuit. Isolating the clamping element may reduce energy dissipation or interference from the clamping element. Isolating the clamping element in the absence of the voltage spike may also prevent any degradation of the clamping element. Examples of the clamping element may include a metal oxide varistor (MOV), a transient voltage separate suppressor (TVS), or the like.

In further embodiments, if it is determined that the clamping element is isolated from the one or more circuit elements of the electrical circuit, the process 600 may continue to monitor the voltage level of the input voltage (block 610). In more embodiments, if it is determined that the clamping element is not isolated from the one or more circuit elements of the electrical circuit, the process 600 may transition a switching element from a conducting state to a non-conducting state to isolate the clamping element from the one or more circuit elements (block 640). Examples of the switching element may include a MOSFET, a solid-state relay, a power switch, or the like. In several embodiments, the switching element may be coupled in series with the clamping element between a pair of terminals of the electrical circuit. When in the non-conducting state, the switching element electrically isolates the clamping element from the one or more circuit elements. Thus, by transitioning the switching element from the conducting state to the non-conducting state an electrical connection between the clamping element and the one or more circuit elements is broken. Subsequently, the process 600 may continue to monitor the voltage level of the input voltage (block 610).

In still more embodiments, if it is determined that the monitored voltage level exceeds the voltage threshold, the process 600 may detect that the voltage spike is present in the input voltage (block 650). The detection of the voltage spike may indicate that the input voltage has deviated from its normal range, and the process 600 may trigger protective actions, such as activating the clamping element, to prevent potential damage to the one or more circuit components of the electrical circuit. In further more embodiments, the process 600 may determine whether the clamping element is coupled to the one or more circuit elements (block 655). For example, the process 600 may check if the clamping element is coupled to the circuit elements in order to provide protection against over-voltage conditions. The determination may ensure that the protection mechanism is in place before the electrical circuit is exposed to any over-voltage risks.

In numerous embodiments, upon determining that the clamping element is coupled to the one or more circuit elements, the process 600 may continue to monitor the voltage level of the input voltage (block 610). The process 600 may continue to monitor the voltage level to detect any further voltage spike that could indicate additional over-voltage conditions. This ensures that the electrical circuit remains continuously protected, without interruption, throughout the duration of the voltage monitoring process.

In further additional embodiments, upon determining that the clamping element is not coupled to the one or more circuit elements, the process 600 may transition the switching element from the non-conducting state to the conducting state to establish a connection between the clamping element and the one or more circuit elements (block 660). In yet several embodiments, when in the conducting state, the switching element electrically couples the clamping element to the one or more circuit elements. Thus, by transitioning the switching element from the non-conducting state to the conducting state the electrical connection between the clamping element and the one or more circuit elements is established. In still many embodiments, the process 600 may generate a control signal that transitions the switching element from the non-conducting state to the conducting state in response to detecting presence of the voltage spike. Once the connection is established, the clamping element may become active and begin to clamp the voltage. Subsequently, the process 600 may continue to monitor the voltage level of the input voltage (block 610). This ensures that the electrical circuit remains continuously protected, without interruption, throughout the duration of the voltage monitoring process.

Although a specific embodiment for protecting an electrical circuit against voltage spikes in an input voltage using an over-voltage transient protection circuit suitable for carrying out the various steps, processes, methods, and operations described herein is discussed with respect to FIG. 6, any of a variety of systems and/or processes may be utilized in accordance with embodiments of the disclosure. For example, in numerous embodiments, a hysteresis mechanism may be utilized to prevent false triggering due to minor fluctuations around the voltage threshold. In many examples, the hysteresis mechanism can be implemented using a configured time period. If it is determined that the voltage level is greater than the voltage threshold and remains higher than the voltage threshold for the configured time period, the process 600 may detect that the voltage spike in the input voltage is present. In further examples, the hysteresis mechanism can be implemented by setting the voltage threshold in the form of a voltage range having a maximum value and a minimum value. In such embodiment, the voltage spike is detected to be present of the voltage level exceeds the maximum value and the voltage spike is detected to be absent or to have ceased if the voltage level drops below the minimum value. In many further examples, the hysteresis mechanism can be implemented by using a combination of the configured time period and the voltage range. The elements depicted in FIG. 6 may also be interchangeable with other elements of FIGS. 1-5 and 7-8 as required to realize a particularly desired embodiment.

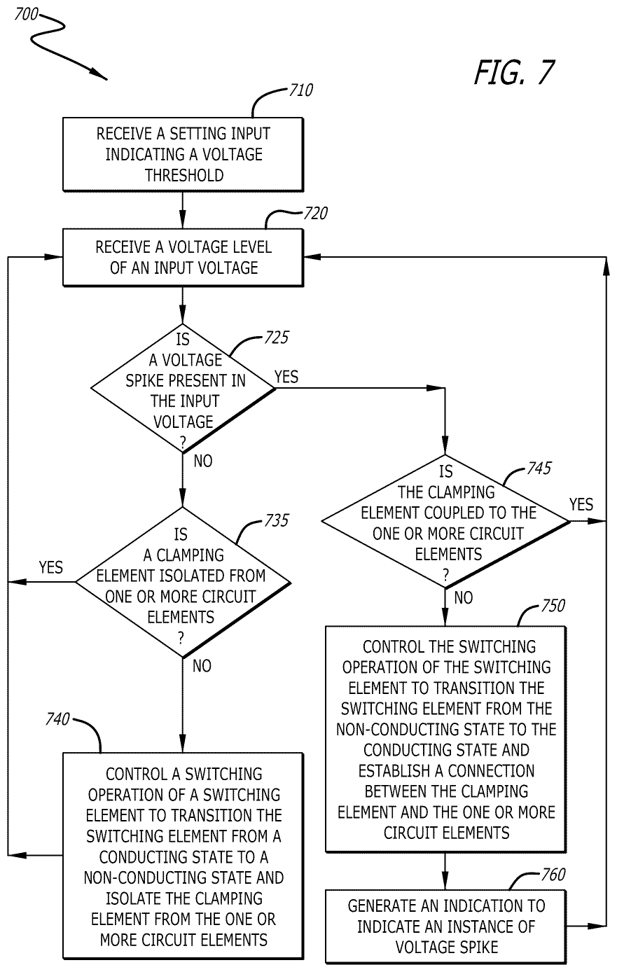

Referring to FIG. 7, a flowchart depicting a process 700 for generating an indication to indicate an instance of voltage spike in accordance with various embodiments of the disclosure is shown. In many embodiments, the process 700 receive a setting input indicating a voltage threshold (block 710). The voltage threshold may be configurable based on the setting input. In examples, the setting input may be a user-defined input or a system-defined input. The process 700 may receive the setting input and configure a switch controller with the voltage threshold. In numerous embodiments, receiving the setting input indicating the voltage threshold may be optional.

In a number of embodiments, the process 700 may monitor a voltage level of an input voltage (block 720). In various embodiments, the process 700 may continuously or periodically monitor the voltage level of the input voltage for an electrical circuit. For example, the process 700 may track fluctuations in the input voltage to detect any significant changes or irregularities, ensuring that any deviations from the normal voltage level are detected.

In many additional embodiments, the process 700 may determine whether a voltage spike is present in the input voltage (block 725). In examples, the voltage spike is detected as present in the input voltage based on the voltage level of the input voltage exceeding the voltage threshold. For example, if the voltage threshold is set at 75V and the monitored voltage reaches 80V (i.e., exceeds the voltage threshold), the process 700 may detect that a voltage spike is present. Further, the voltage spike is detected as absent in the input voltage based on the voltage level of the input voltage being less than the voltage threshold.

In many further embodiments, upon determining that the voltage spike is absent in the input voltage, the process 700 may determine if a clamping element is isolated from one or more circuit elements of the electrical circuit (block 735). For example, if the voltage spike is absent, the clamping element may no longer be required to protect the electrical circuit. Therefore, it may be beneficial to determine if the clamping element is isolated from the circuit elements. Isolating the clamping element may ensure that the electrical circuit can resume normal operation without energy dissipation or interference from the clamping element, which may otherwise remain active. This also prevents any degradation of the clamping element, as the clamping element is only needed during voltage spikes.

In further embodiments, if it is determined that the clamping element is isolated from the one or more circuit elements of the electrical circuit, the process 700 may continue to receive the voltage level of the input voltage (block 720). In further more embodiments, if it is determined that the clamping element is not isolated from the one or more circuit elements of the electrical circuit, the process 700 may control a switching operation of a switching element to transition the switching element from a conducting state to a non-conducting state and isolate the clamping element from the one or more circuit elements (block 740). The switching element may be coupled in serial with the clamping element. Depending upon whether the switching element is in the conducting state or the non-conducting state, the clamping element may be coupled to or isolated from the one or more circuit elements. In other words, the switching element may be utilized to electrically connect or disconnect the clamping device from the one or more circuit elements. This may ensure that the electrical circuit resumes normal operation without energy loss, interference, or potential damage caused by the continuous operation of the clamping element. Additionally, wear or degradation of the clamping element is prevented. Subsequently, the process 700 may continue to receive the voltage level of the input voltage (block 720).

In further embodiments, upon determining that the voltage spike is present in the input voltage, the process 700 may determine whether the clamping element is coupled to the one or more circuit elements (block 745). The clamping element may be normally isolated from the electrical circuit during normal operating conditions. In various embodiments, the process 700 may check if the clamping element is coupled to the circuit elements in order to provide protection against over-voltage conditions. The determination may ensure that the protection mechanism is in place before the electrical circuit is exposed to any over-voltage risks. In many more embodiments, upon determining that the clamping element is coupled to the one or more circuit elements, the process 700 may continue to receive the voltage level of the input voltage (block 720).

In yet further embodiments, upon determining that the clamping element is not coupled to the one or more circuit elements, the process 700 may control the switching operation of the switching element to transition the switching element from the non-conducting state to the conducting state and establish a connection between the clamping element and the one or more circuit elements (block 750). In several embodiments, the process 700 may generate a control signal to control the switching operation of the switching element. When the connection between the clamping element and the one or more circuit elements is established, the clamping element may absorb and dissipate excess energy from the voltage spike, limiting the voltage within a safe range to protect sensitive circuit components.

In various embodiments, once the connection between the clamping element and one or more circuit elements is established, the process 700 may generate an indication to indicate an instance of voltage spike (block 760). In yet many embodiments, the process 700 may generate the indication based on the voltage spike being present in the input voltage. The process 700 may track one or more instances of voltage spikes in the input voltage based on the generated indication. The tracking of the one or more instances of voltage spikes may assist in monitoring frequency, duration, and intensity of voltage spikes, providing valuable data for system diagnostics and future protection adjustments. The tracked information may also be used to analyze the performance of the clamping element. In still many embodiments, upon generating the indication to indicate the instance of voltage spike, the process 700 may continue to receive the voltage level of the input voltage (block 720).

Although a specific embodiment for process 700 for generating the indication to indicate the instance of voltage spike in accordance with various embodiments of the disclosure is shown is suitable for carrying out the various steps, processes, methods, and operations described herein is discussed with respect to FIG. 7, any of a variety of systems and/or processes may be utilized in accordance with embodiments of the disclosure. For example, in yet various embodiments, the process 700 may detect a cessation of the voltage spike in the input voltage and re-isolate the clamping element from the one or more circuit elements in response to detecting the cessation of the voltage spike in the input voltage. The elements depicted in FIG. 7 may also be interchangeable with other elements of FIGS. 1-6 and 8 as required to realize a particularly desired embodiment.

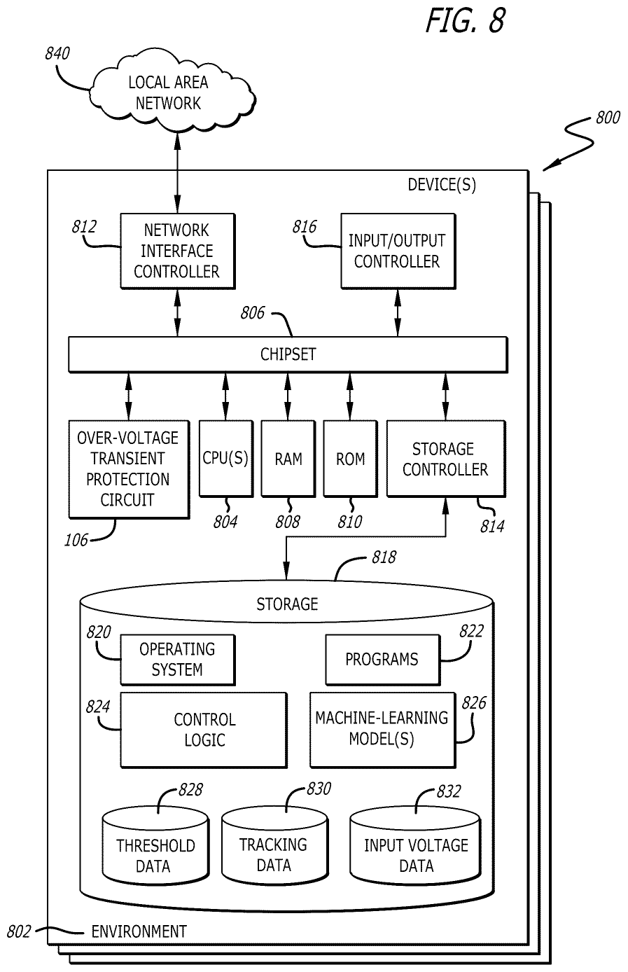

Referring to FIG. 8, a conceptual block diagram of a device 800 capable of executing a control logic 824 for implementing the functionality and embodiments described above is shown. The embodiment of the conceptual block diagram depicted in FIG. 8 can illustrate a conventional server computer, a workstation, a desktop computer, a laptop, a tablet, a network appliance, an electronic reader (e-reader), a smartphone, or other computing device, and can be utilized to execute any of the application and/or logic components presented herein. The device 800 may, in some examples, correspond to a physical device or to a virtual resource described herein. The device 800 can be a network device (for example, an access point, a switch, or a controller), a client device, or the like in accordance with various embodiments of the disclosure.

In many embodiments, the device 800 may include an environment 802 such as a baseboard or a “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In a number of embodiments, one or more processors 804, such as, but not limited to, central processing units (CPUs) can be configured to operate in conjunction with a chipset 806. The processor(s) 804 can be standard programmable CPUs that perform arithmetic and logical operations necessary for the operation of the device 800.

In a variety of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to the over-voltage transient protection circuit 106 (of FIGS. 1-3) for protecting various components of the device 800 from damages due to voltage spikes. The chipset 806 can provide an interface to a random-access memory (RAM) 808, which can be utilized as the main memory in the device 800 in some embodiments. The chipset 806 can further be configured to provide an interface to a computer-readable storage medium such as a read-only memory (ROM) 810 or a Non-Volatile RAM (NVRAM) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Different embodiments of the device 800 can be configured to operate in a networked environment using logical connections to remote computing devices and computer systems through a network, such as the network 840. The chipset 806 can include functionality for providing network connectivity through a Network Interface Controller (NIC) 812, which may include a gigabit Ethernet adapter or similar component. The NIC 812 can be capable of connecting the device 800 to other devices over the network 840. It is contemplated that multiple NICs 812 may be present in the device 800, connecting the device 800 to other types of networks and remote systems.

In more embodiments, the device 800 can be connected to a storage 818 that provides non-volatile storage for data accessible by the device 800. The storage 818 can, for example, store an operating system 820, programs 822, threshold data 828, tracking data 830, and input voltage data 832, which are described in greater detail below. The storage 818 can be connected to the environment 802 through a storage controller 814 connected to the chipset 806. In additional embodiments, the storage 818 can include one or more physical storage units. The storage controller 814 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The device 800 can store data within the storage 818 by transforming the physical state of the physical storage units to reflect the information being stored. The specific transformation of physical state can depend on various factors. Examples of such factors can include, but are not limited to, the technology utilized to implement the physical storage units, whether the storage 818 is characterized as primary or secondary storage, and the like. For example, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and/or any components included therein, may be supported by one or more devices similar to the device 800. Stated otherwise, some or all of the operations performed by the cloud computing network, and/or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, Erasable programmable ROM (EPROM), Electrically-Erasable programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 818 can store an operating system 820 utilized to control the operation of the device 800. According to one embodiment, the operating system 820 includes the LINUX operating system. According to another embodiment, the operating system 820 includes the Windows® server operating system from Microsoft Corporation of Redmond, Washington. According to further embodiments, the operating system 820 can include the UNIX operating system or one of its variants. It should be appreciated that other operating systems can also be utilized. The storage 818 can store other system or application programs and data utilized by the device 800.

In still more embodiments, the storage 818 or other computer-readable storage media is encoded with computer-executable instructions which, when loaded into the device 800, may transform the device 800 from a general-purpose computing system into a special-purpose computer capable of implementing the embodiments described herein. These computer-executable instructions may be stored as programs 822 (e.g., applications) and transform the device 800 by specifying how the processor(s) 804 can transition between states, as described above. In still further embodiments, the device 800 has access to computer-readable storage media storing computer-executable instructions which, when executed by the device 800, perform the various processes described above with regard to FIGS. 1-7. In still additional embodiments, the device 800 can also include computer-readable storage media having instructions stored thereupon for performing any of the other computer-implemented operations described herein.

In some more embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 may not include all of the components shown in FIG. 8, and can include other components that are not explicitly shown in FIG. 8, or may utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

In yet various embodiments, the device 800 can include a control logic 824 that may be responsible for tracking one or more instances of voltage spikes in an input voltage based on an indication on a voltage spike being present in the input voltage. In embodiments where the device 800 corresponds to the controller, the control logic 824 can be configured to perform various operations such as, but not limited to, receiving a monitored voltage level in an input voltage; determining a voltage threshold based on the monitored voltage level received over a time period; and providing a setting input that configures a switch controller with the voltage threshold.

In embodiments where the device 800 corresponds to a network device, for example, an access point, the control logic 824 can be configured to perform various operations such as, but not limited to, transmitting a request for monitored voltage level to a switch controller; and receiving the monitored voltage level from the switch controller.

Those skilled in the art will recognize that the control logic 824 can include various hardware and/or software deployments and can be configured in a variety of ways. In still yet more embodiments, the control logic 824 can be configured as a standalone device, exist as a logic in another network device, be distributed among various network devices operating in tandem, or remotely operated as part of a cloud-based network management tool. In many further embodiments, one or more servers can be configured with the control logic 824 or can otherwise operate as the control logic 824. In many additional embodiments, the control logic 824 may operate on one or more servers connected to a communication network, for example, the Internet. The communication network can include wired networks or wireless networks. The control logic 824 can be provided as a cloud-based service that can service remote networks, such as, but not limited to a deployed network. Further, in still yet further embodiments, the control logic 824 may be operated as a distributed logic across multiple network devices. In an embodiment, the control plane node can operate as the control logic 824 or may have multiple devices operate as the control logic 824 in a distributed manner.

In several embodiments, the storage 818 can include threshold data 828. The threshold data 828 may relate to voltage thresholds that can be used to clamp voltage spikes. For example, the threshold data 828 may include voltage thresholds. The voltage thresholds can be static or dynamic. In further additional embodiments, the threshold data 828 may be utilized by the control logic 824 to provide a setting input that configures a switch controller of the over-voltage transient protection circuit 106 with a voltage threshold.

In several more embodiments, the storage 818 can include tracking data 830. The tracking data 830 may relate to instances of voltage spikes in an input voltage. The tracking data 830 can include a plurality of instances of voltage spikes in the input voltage. In several embodiments, in addition to the threshold data 828, the tracking data 830 may be utilized by the control logic 824 to track a number of over-voltage events. In numerous embodiments, the storage 818 can include input voltage data 832. The input voltage data 832 may include input voltages of various circuit components or the device 800.

In numerous additional embodiments, data may be processed into a format usable by a machine-learning (“ML”) model 826 (e.g., feature vectors), and or other pre-processing techniques. The ML model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models. The ML model 826 may be configured to analyze the threshold data 828, the tracking data 830, and the input voltage data 832 for detecting whether a voltage spike is present in an input voltage. In further additional embodiments, the ML model 826 may be utilized to identify various parameters to include in the threshold data 828, the tracking data 830, and the input voltage data 832. For example, the ML model 826 may analyze the threshold data 828, the tracking data 830, and the input voltage data 832 and identify parameters that are required to augment the threshold data 828, the tracking data 830, and the input voltage data 832.

Although a specific embodiment for a device 800 capable of executing components and the control logic 824 for implementing the functionality and embodiments suitable for carrying out the various steps, processes, methods, and operations described herein is discussed with respect to FIG. 8, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the control logic 824 acts in tandem between the devices. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary”, or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An electrical circuit, comprising:
a pair of terminals configured to receive an input voltage;
one or more circuit elements coupled between the pair of terminals; and
an over-voltage transient protection circuit coupled between the pair of terminals and to the one or more circuit elements, wherein the over-voltage transient protection circuit comprises:
a clamping element; and
a switching element coupled in series with the clamping element between the pair of terminals and operable in a conducting state or a non-conducting state based on a voltage spike being present or absent in the input voltage, respectively, wherein:
in the non-conducting state, the switching element isolates the clamping element from the one or more circuit elements, and
in the conducting state, the switching element establishes a connection between the clamping element and the one or more circuit elements.

2. The electrical circuit of claim 1, wherein a maximum continuous operating voltage associated with the clamping element is less than a continuous voltage associated with the electrical circuit.

3. The electrical circuit of claim 1, wherein the over-voltage transient protection circuit further comprises a switch controller configured to detect whether the voltage spike is present in the input voltage based on a voltage level of the input voltage and a voltage threshold.

4. The electrical circuit of claim 3, wherein the voltage spike is detected as absent in the input voltage based on the voltage level of the input voltage being less than the voltage threshold.

5. The electrical circuit of claim 3, wherein the voltage spike is detected as present in the input voltage based on the voltage level of the input voltage exceeding the voltage threshold.

6. The electrical circuit of claim 3, wherein the switch controller is coupled to the switching element and configured to control a switching operation of the switching element based on the detection of whether the voltage spike is present in the input voltage.

7. The electrical circuit of claim 6, wherein controlling the switching operation of the switching element comprises operating the switching element in the non-conducting state based on the detection that the voltage spike is absent in the input voltage.

8. The electrical circuit of claim 6, wherein controlling the switching operation of the switching element comprises causing the switching element to transition from the non-conducting state to the conducting state in response to the detection that the voltage spike is present in the input voltage.

9. The electrical circuit of claim 6, wherein controlling the switching operation of the switching element comprises operating the switching element in the conducting state at least until the voltage spike in the input voltage persists.

10. The electrical circuit of claim 6, wherein controlling the switching operation of the switching element comprises causing the switching element to transition from the conducting state to the non-conducting state in response to cessation of the voltage spike in the input voltage.

11. The electrical circuit of claim 3, wherein the switch controller is further configured to receive a setting input for the voltage threshold.

12. The electrical circuit of claim 11, wherein the voltage threshold is configurable based on the setting input.

13. The electrical circuit of claim 3, wherein the over-voltage transient protection circuit further comprises an input voltage monitoring circuit coupled to the switch controller and configured to:
monitor the voltage level of the input voltage; and
transmit the monitored voltage level.

14. The electrical circuit of claim 13, wherein to detect whether the voltage spike is present in the input voltage, the switch controller is further configured to receive the voltage level from the input voltage monitoring circuit.

15. The electrical circuit of claim 13, further comprising a control logic configured to:
receive the monitored voltage level;
determine the voltage threshold based on the monitored voltage level received over a time period; and
provide a setting input that configures the switch controller with the voltage threshold.

16. The electrical circuit of claim 1, wherein the over-voltage transient protection circuit is further configured to generate an indication based on the voltage spike being present in the input voltage.

17. The electrical circuit of claim 16, further comprising a control logic configured to track one or more instances of voltage spikes in the input voltage based on the generated indication.

18. An over-voltage transient protection circuit to protect an electrical circuit from voltage spikes, comprising:
a clamping element that has a maximum continuous operating voltage lower than a continuous voltage associated with the electrical circuit;
a switching element coupled in series with the clamping element and operable in a conducting state or a non-conducting state; and
a switch controller coupled to the switching element and configured to transition the switching element from the non-conducting state to the conducting state in response to a voltage spike.

19. A method to protect an electrical circuit from voltage spikes, comprising:
detecting, by an over-voltage transient protection circuit in the electrical circuit, a voltage spike in an input voltage, wherein the over-voltage transient protection circuit comprises a clamping element that is normally isolated from one or more circuit elements of the electrical circuit, and has a maximum continuous operating voltage lower than a continuous voltage associated with the electrical circuit; and
establishing a connection between the clamping element and the one or more circuit elements in response to detecting the voltage spike.

20. The method of claim 19, further comprising:
detecting a cessation of the voltage spike in the input voltage; and
re-isolating the clamping element from the one or more circuit elements in response to detecting the cessation of the voltage spike in the input voltage.
